(19) United States
(12) Patent Application Publication
(10) Pub. No.: US 2012/0119034 A1
(43) Pub. Date: May 17, 2012

(54) Deorbiting a Spacecraft from a Highly Inclined Elliptical Orbit

(75) Inventor: Brian Kemper, Sunnyvale, CA (US)

(73) Assignee: SPACE SYSTEMS/LORAL, INC., Palo Alto, CA (US)

(21) Appl. No.: 12/829,242

(22) Filed: Jul. 1, 2010

Related U.S. Application Data
(60) Provisional application No. 61/222,613, filed on Jul. 2, 2009.

(51) Int. Cl. B64G 1/10; G05D 1/10

(52) U.S. Cl. 244/158.5

(57) ABSTRACT

Deorbiting of an earth-orbiting satellite is accomplished by executing an orbit transfer maneuver, the orbit transfer maneuver resulting in transference of the satellite from an operational orbit to a disposal orbit, where the disposal orbit is substantially circular and has a nominal radius of approximately, 31,000 kilometers. The operational orbit may be substantially geosynchronous and have at least one of (i) an inclination of greater than 10 degrees and (ii) a nominal eccentricity greater than 0.1. Alternatively, the operational orbit may be a medium earth orbit.

### CROSS-REFERENCE TO RELATED APPLICATIONS

The present application claims the priority benefit of commonly owned U.S. Provisional Patent Application No. 61/222,613, filed Jul. 2, 2009, entitled “Deorbiting a Spacecraft from a Highly Inclined Elliptical Orbit”, which is hereby incorporated in its entirety by reference into the present patent application.

### TECHNICAL FIELD

This invention relates generally to spacecraft and, in particular, to methods and apparatus for providing a safe disposal orbit for a satellite at the end of its useful life.

### BACKGROUND OF THE INVENTION

The assignee of the present invention manufactures and deploys spacecraft for communications and broadcast services. Many such spacecraft operate in a geosynchronous orbit having a period equal to one sidereal day (approximately 23.93 hours).

A particular type of geosynchronous orbit is a geostationary orbit (GSO), characterized as being substantially circular and co-planar with the Earth's equator. An elevation angle from a user located on the Earth to a satellite in GSO is a function of the user's latitude. When a service area on the ground intended to receive communications or broadcast services (hereinafter, an “intended service area”) is at a relatively high latitude, the elevation angle is relatively small. At the latitudes of service areas containing many population centers of interest, for example in North America, Europe, and Asia, the elevation angle from the intended service area to the GSO spacecraft is small enough that service outages, for example from physical blockage, multipath fading, and foliage attenuation, are problematic.

To mitigate this problem, satellites operable in inclined, elliptical geosynchronous orbits have been proposed, as described, for example in Briskman, et al., U.S. Pat. No. 6,223,019, (hereinafter, Briskman) the disclosure of which is hereby incorporated in its entirety into the present patent application. A geosynchronous, highly inclined, elliptical orbit (HIEO) may be selected such that the orbit's apogee is located at a pre-selected, substantially constant, longitude and latitude. A satellite disposed in an HIEO can, during much of its orbital period (e.g., sixteen hours out of twenty four) enable higher elevation angles to a user than a GSO satellite.

Orbital debris has become a major concern in recent years. One class of orbital “debris” consists of entire satellites, retired after the end of their operational life. The Federal Communications Commission (FCC) has promulgated regulations for commercial communications satellites that addressed orbital debris concerns, including procedures for handling of satellites at end of life. “In the Matter of Orbital Debris”, IB Docket No. 02-54, Second Report and Order, FCC04-130, Jun. 21, 2004, hereinafter, the “FCC Order”, hereby incorporated by reference in its entirety. To mitigate the risk from retired satellites, the FCC Order mandated a deorbit capability requirement.

There are several known methods to accomplish satellite deorbiting. One method is to maneuver the satellite into an orbit which results in the satellite's reentry into the earth's atmosphere. This is generally impractical for a satellite normally operating in high orbits such as GSO and geosynchronous HIEO, because the energy required for such a maneuver is prohibitive. A second method is to place the satellite in outer space. This requires achieving near escape velocity from its earth orbit and, again, is not desirable because the satellite on-board propellant required to provide the necessary energy is prohibitively high.

A preferable approach is to maneuver the satellite at the end of useful life into a disposal orbit. A desirable disposal orbit may be characterized as being (1) currently unused and unlikely to be used in the future by operational satellites and (2) stable, so that the satellite stays in or near this orbit for a long time (e.g., a century). As an example of this approach, with respect to spacecraft normally operating in GSO, the FCC Order imposed the following deorbit capability requirement: that such spacecraft be relocated, at the end of useful life to a disposal orbit having a perigee altitude of no less than 235 km above the normal GSO altitude of 35,786 km.

The FCC Order expressly declined to promulgate a rule concerning non GSO spacecraft such as those operable in HIEO. Instead, Operators of such spacecraft are required to submit an orbital debris mitigation plan to the FCC regarding spacecraft design and operation in connection with a request for FCC authorization to construct and operate the spacecraft.

It is necessary to plan for satellite deorbiting during the satellite's initial design, since sufficient on-board propellant must be available at the satellite's end of life to perform the orbital changes. The satellite design for achieving the disposal orbit must also consider ancillary matters such as on-board thruster usage and tracking, telemetry and command coverage of the satellite during its movement from the operating orbit to the disposal orbit, which can be lengthy.

### SUMMARY OF INVENTION

The present inventor has discovered that a satellite normally operating in a HIEO characterized as having a nominally geosynchronous period, a nominal inclination (i) of approximately 56°, and a nominal eccentricity (e) of approximately 0.25 may be advantageously deorbited to a disposal orbit characterized as substantially circular having a nominal radius of approximately 31000 km.

In an embodiment, deorbiting an earth-orbiting satellite is accomplished by executing an orbit transfer maneuver, the orbit transfer maneuver resulting in transference of the satellite from an operational orbit to a disposal orbit. The operational orbit is substantially geosynchronous and has at least one of (i) an inclination of greater than 10 degrees and (ii) a nominal eccentricity greater than 0.1. The disposal orbit is substantially circular and has a nominal radius of approximately, 31,000 kilometers.

In a further embodiment, the operational orbit has an inclination of greater than 10 degrees, and a nominal eccentricity greater than 0.1. The disposal orbit may have substantially the same nominal inclination as the operational orbit.

In another embodiment, the operational orbit is substantially geosynchronous and has at least one of: (i) an inclination of approximately 56 degrees; and (ii) a nominal eccentricity of approximately 0.25. The disposal orbit may have substantially the same nominal inclination as the operational orbit.

In a yet further embodiment, deorbiting an earth-orbiting satellite is accomplished by executing an orbit transfer maneuver, said orbit transfer maneuver resulting in transference of said satellite from an operational orbit to a disposal orbit. The operational orbit is substantially geosynchronous and has a nominal inclination of greater than 10 degrees. The disposal orbit is substantially circular, and has (i) a nominal radius of approximately 31,000 kilometer and (ii) substantially the same nominal inclination as the operational orbit.

In another embodiment, deorbiting an earth-orbiting satellite is accomplished by executing an orbit transfer maneuver, the orbit transfer maneuver resulting in transference of said satellite from an operational orbit to a disposal orbit, where the operational orbit being a medium earth orbit. The disposal orbit is substantially circular and has a nominal radius of approximately 31,000 kilometer.

### BRIEF DESCRIPTION OF THE DRAWINGS

Features of the invention are more fully disclosed in the following detailed description of the preferred embodiments, reference being had to the accompanying drawings, in which:

FIG. 1 illustrates orbital eccentricity as a function of time for one embodiment of the invention.

FIG. 2 illustrates inclination as a function of time for one embodiment of the invention.

FIG. 3 illustrates orbital radius as a function of time for one embodiment of the invention.

Throughout the drawings, the same reference numerals and characters, unless otherwise stated, are used to denote like features, elements, components, or portions of the illustrated embodiments. Moreover, while the subject invention will now be described in detail with reference to the drawings, the description is done in connection with the illustrative embodiments. It is intended that changes and modifications can be made to the described embodiments without departing from the true scope and spirit of the subject invention as defined by the appended claims.

### DETAILED DESCRIPTION OF THE PREFERRED EMBODIMENTS

Specific exemplary embodiments of the invention will now be described with reference to the accompanying drawings. This invention may, however, be embodied in many different forms, and should not be construed as limited to the embodiments set forth herein. Rather, these embodiments are provided so that this disclosure will be thorough and complete, and will fully convey the scope of the invention to those skilled in the art.

It will be understood that when an element is referred to as being “connected” or “coupled” to another element, it can be directly connected or coupled to the other element, or intervening elements may be present. Furthermore, “connected” or “coupled” as used herein may include wirelessly connected or coupled. It will be understood that although the terms “first” and “second” are used herein to describe various elements, these elements should not be limited by these terms. These terms are used only to distinguish one element from another element. Thus, for example, a first user terminal could be termed a second user terminal, and similarly, a second user terminal may be termed a first user terminal without departing from the teachings of the present invention. As used herein, the term “and/or” includes any and all combinations of one or more of the associated listed items. The symbol “/” is also used as a shorthand notation for “and/or”.

The presently disclosed techniques may be advantageously implemented in conjunction with a spacecraft operating in a non-geosynchronous earth orbit. In an exemplary embodiment, the spacecraft's orbit may be highly inclined with respect to the Earth's equator and substantially non-circular (i.e., elliptical).

In an embodiment, a satellite normally operating in a HIEO characterized as having a nominally geosynchronous period, a nominal inclination (i) of approximately 56°, and a nominal eccentricity (e) of approximately 0.25 may be advantageously deorbited to a novel disposal orbit characterized as substantially circular and having a nominal radius of approximately 31000 km.

Said novel disposal orbit (NDO) has been found by the inventor to provide important benefits. First, the amount of propellant required to achieve this orbit is significantly less than that required to achieve solutions known to the prior art, e.g., a disposal orbit having a perigee radius higher than a standard GSO, escape from earth orbit, or de-orbit to the earth. Second, analysis of the NDO parameters indicated the NDO is stable for at least one hundred years.

In an embodiment, the NDO may have the same nominal inclination as the operational HIEO, so as to minimize propellant expenditures necessary at end of life to change the inclination. Although inclined orbits, generally, have a tendency to be less stable than equatorial orbits, analysis has shown that the NDO is stable for over one hundred years, notwithstanding a substantial inclination. The analysis took into account, for example, solar radiation pressure on the satellite, solar, lunar and earth gravity effects, including effects due to the earth's oblateness.

The NDO orbital altitude may be selected for long term stability and minimization of deorbit propellant. Advantageously, the NDO orbit altitude may also be selected taking into account existing and foreseen operational satellite orbits. In a preferred embodiment, the NDO may have a circular orbital radius of approximately 31000 km (defined herein as the height of the orbit above the earth's center). The foregoing orbital radius is above that proposed for the Galileo navigation satellite constellation and substantially below the geostationary orbit. It is an orbital radius where the Van Allen radiation is relatively high so future development use by operational satellites appears improbable.

In some embodiments a reduction of inclination may also be achieved at the time of deorbiting, however, this reduction is not generally necessary.

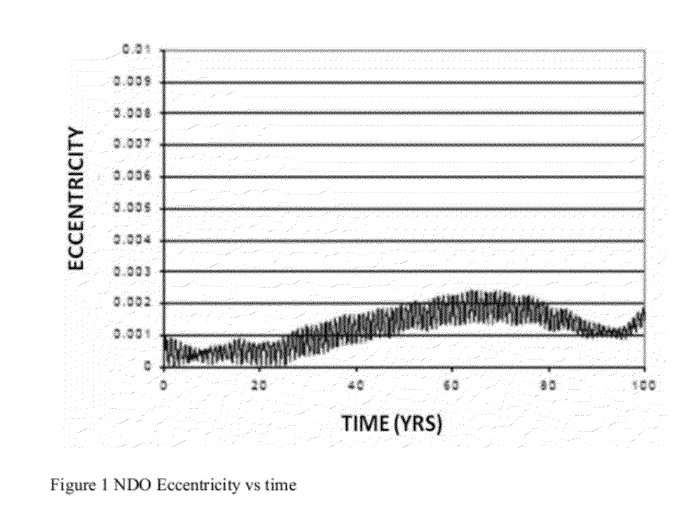

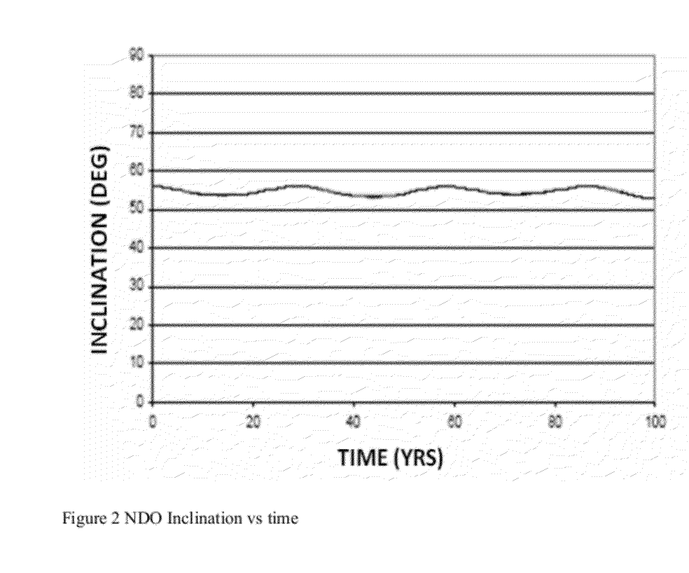

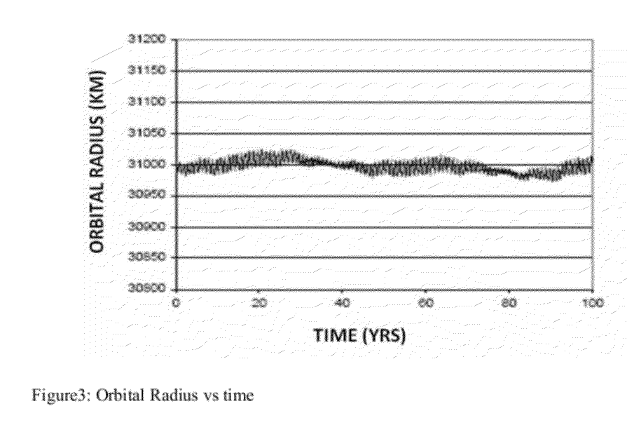

Results of the analysis of long-term stability of an NDO having a radius of approximately 31,000 km are shown in FIGS. 1-3. FIG. 1 illustrates orbital eccentricity as a function of time. FIG. 2 illustrates inclination as a function of time. FIG. 3 illustrates orbital radius as a function of time. Variation of the foregoing three key orbital parameters over the extended period of one hundred years is shown to be small.

Transfer of a satellite from an HIEO or other non-GSO orbit to the NDO may be accomplished near satellite end of life by various means. For example, after the satellite has reached the end of its operational life, a series of maneuvers may be performed to lower the orbit from HIEO into the NDO.

In an embodiment, a maneuver (or maneuvers) are performed at perigee in order to circularize the orbit. If the perigee of the HIEO orbit is higher than that of the disposal orbit, a maneuver (or maneuvers) may also be performed at apogee. These maneuvers may be in-plane Hohmann transfer maneuvers.

When there exists sufficient propellant and a need to reduce the inclination of the orbit, maneuvers may also be performed off-apse and at a firing angle that is not in-plane. The details of these adjustments are heavily dependent on the specific case.

The mechanism by which the maneuver is performed will have an impact on mission design considerations, but does not fundamentally affect the NDO. For example, a high-thrust engine could be used; alternately, low-thrust ion or plasma thrusters could be used. Time-of-flight and required propellant would be different in these two scenarios, but the ultimate disposal orbit reached would be the same.

The initial starting orbit does not need to be a HIEO orbit—there are other possible mission orbits that could benefit from the NDO disclosed herein. For example, satellites normally operating in medium earth orbits and near-GSO type orbits would be possible candidates for this concept.

In light of the foregoing discovery and analysis, the FCC has approved a deorbit plan featuring the NDO. Satellite CD Radio, Inc; “Application to Modify FM-6 Satellite Authorization”; File No. SAT-MOD-20081024-00209 (filed Oct. 24, 2008)

What is claimed is:

1. A method comprising:
deorbiting an earth-orbiting satellite by executing an orbit transfer maneuver, said orbit transfer maneuver resulting in transference of said satellite from an operational orbit to a disposal orbit,
said operational orbit being substantially geosynchronous and having at least one of (i) an inclination of greater than 10 degrees and (ii) a nominal eccentricity greater than 0.1, and
said disposal orbit being substantially circular and having a nominal radius of approximately, 31,000 kilometers.

2. The method of claim 1, wherein the operational orbit has an inclination of greater than 10 degrees, and a nominal eccentricity greater than 0.1.

3. The method of claim 2, wherein the disposal orbit has substantially the same nominal inclination as the operational orbit.

4. The method of claim 1, wherein the operational orbit is substantially geosynchronous and has at least one of: (i) an inclination of approximately 56 degrees; and (ii) a nominal eccentricity of approximately 0.25.

5. The method of claim 4, wherein the disposal orbit has substantially the same nominal inclination as the operational orbit.

6. A method comprising:
deorbiting an earth-orbiting satellite by executing an orbit transfer maneuver, said orbit transfer maneuver resulting in transference of said satellite from an operational orbit to a disposal orbit,
said operational orbit being substantially geosynchronous and having a nominal inclination of greater than 10 degrees; and
said disposal orbit being substantially circular, and having (i) a nominal radius of approximately 31,000 kilometer and (ii) substantially the same nominal inclination as the operational orbit.

7. The method of claim 6, wherein the operational orbit has a nominal eccentricity greater than 0.1.

8. The method of claim 6, wherein the operational orbit has a nominal eccentricity of approximately 0.25.

9. A method comprising:
deorbiting an earth-orbiting satellite by executing an orbit transfer maneuver, said orbit transfer maneuver resulting in transference of said satellite from an operational orbit to a disposal orbit,
said operational orbit being a medium earth orbit, and
said disposal orbit being substantially circular and having a nominal radius of approximately 31,000 kilometer.
